(19) United States
(12) Patent Application Publication
(10) Pub. No.: US 2007/0124480 A1
(43) Pub. Date: May 31, 2007

(54) System and method for persistent user tracking using cached resource content

(76) Inventors: Ronen Heled, Kiryat-Ono (IL); Amit Klein, Herzliya (IL)

Correspondence Address: PEARL COHEN ZEDEK LATZER, LLP, 1500 BROADWAY 12TH FLOOR, NEW YORK, NY, 10036, US

(21) Appl. No.: 11/602,506

(22) Filed: Nov. 21, 2006

Related U.S. Application Data
(60) Provisional application No. 60/738,037, filed on Nov. 21, 2005.

(51) Int. Cl. G06F 15/16

(52) U.S. Cl. 709/227

(57) ABSTRACT

Embodiments of the present invention include a system, device, and method for persistent user tracking including associating a session management item with a client computer identification item, wherein said session management item and said client computer identification item are both associated with a single value of a marker. Embodiments of the present invention include a system, device, and method for persistent user tracking including, associating a first session management item, the first session management item pertaining to a session conducted by a user on a first server with a client computer identification item, and associating a second session management item, the second session management item pertaining to a session conducted by the user on a second server with the client computer identification item. In some embodiments, the client computer identification item may be received from a client computer by a code executed thereon.

### PRIOR APPLICATION DATA

The present application claims benefit of prior provisional application Ser. No. 60/738,037, filed on Nov. 21, 2005, entitled “SYSTEM AND METHOD FOR PERSISTENT USER TRACKING USING A CACHED RESOURCE CONTENT”, incorporated by reference herein in its entirety.

### BACKGROUND OF THE INVENTION

“Persistent user tracking” is a well-known and extensively discussed issue in the Internet world. Persistent user tracking mechanisms may be used to identify and track client processes, for example, client operations via an Internet browser. Tracking may include associating multiple independent client processes, for example, requests to one or more servers, to the source of the client request.

Persistent user tracking systems may use various means to identify client processes, including, for example, persistent HTTP Cookies, HTTP Cache headers or other identifiers or trackers for client-end processes.

Persistent user tracking may provide information associating independent or sporadic client requests throughout a period of time or over one or more client process sessions to a client identity or one or more client specific sessions.

Persistent user tracking systems may balance concerns regarding client anonymity with the need to identify or track clients, for example, for security or providing a third party service provider with client specific information, for example, for designing client specific accounts. Relatively consensual persistent user tracking systems may use optional client process identifiers, such as HTTP Cookies. HTTP Cookies may include HTTP headers with values and/or other restriction entities set by a remote server. HTTP Cookies are often used to substantially only with client permission. For example, HTTP Cookies may be accepted or rejected by a client substantially each time client tracking is performed. If a client accepts an HTTP cookie associated with a client request to a domain provided by a remote server, the value of the http cookie may be sent to the remote server in future requests to the domain, for example, provided that the client request satisfies the restriction entities of the cookie. Persistent user tracking systems using HTTP cookies may implement additional privacy restrictions to misuse of the systems by server providers. However, if the client rejects or deletes the HTTP cookie, service providers may not have access to client information.

Compulsory client tracking may be used, for example, for security measures to prevent fraudulent users from averting detection. One such compulsory persistent user tracking system uses a method referred to as “cache tagging”, as described in http://sourcefrog.net/projects/meantime/, (“meantime—non consensual http user tracking using caches” by Martin Pool, published in the year 2000). Cache tagging systems may use client-end cacheable resources for tracking client processes rather than for their intended purpose. If a client sends a request to a specific domain provided by a server, the server may associate or attach a client specific tag to the client side cached request. In future client requests to the same domain, the server may identify the tagged client request and retrieve a string of client side cached resources, headers, or values associated therewith, spanning from the initial tagged client request to the present client request. For example, the server may use client side cached resources such as “ETag” and “Last-Modified” headers, to store persistent tracking data, to validate the integrity of a cached resource copy, or any other suitable function.

Maintaining anonymity using a cache tagging systems may prove relatively difficult for a client. Thus, cache tagging may provide effective solutions for fraud detection schemes, for example, in Online tracking systems such as those used by financial institutions (FIs).

However, cache tagging systems currently pose several problems. Cache tagging systems, such as the system described in http://sourcefrog.net/projects/meantime/, may only allow a server to track client processes if the client makes repeated requests to the one or more domains provided by the specific server. Additional servers may be unaware of such potentially critical client processes.

Furthermore, it may be critical for a cache tagging mechanisms to identify distinct or desired sessions, such as a current live session, over which desired client process information may span. However, cache tagging systems use separate cache tagging mechanisms and session management mechanisms. Thus, cache tagging mechanisms may not identify the relevant or desired client process information, for example, that spans one or more critical sessions.

A need exists for cache tagging systems that offer wider client tracking capabilities.

### SUMMARY

Embodiments of the present invention include a system, device, and method for persistent user tracking including associating a session management item with a client computer identification item, wherein said session management item and said client computer identification item are both associated with a single value of a marker.

Embodiments of the present invention include a system, device, and method for persistent user tracking including, associating a first session management item, the first session management item pertaining to a session conducted by a user on a first server with a client computer identification item, and associating a second session management item, the second session management item pertaining to a session conducted by the user on a second server with the client computer identification item. In some embodiments, the client computer identification item may be received from a client computer by a code executed thereon.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of a cache tagging system, including one or more servers and one or more computers or terminals, for tracking client processes using cache tagging mechanisms, according to one embodiment of the present invention; and

FIG. 2 is a flowchart of a method for persistent user tracking according to an embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

The processes presented herein are not inherently related to any particular computer, server, terminal or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, as apparent from the following discussions, throughout the specification discussions utilizing terms such as “processing,” “computing,” “calculating,” “determining,” or the like, refer to the action and/or processes of a computer or workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention include a system, device, and method for tracking client processes by tagging client cached resource content on the client side, as opposed to the server side of one or more specific servers. Such embodiments may enable additional servers to access specific client process information for tracking the client. The servers may access relevant or desired client process information, for example, that spans one or more sessions. The relevant information may include cached resources marked, for example, by client or server side tagging, such as a string of HTTP headers, or values associated therewith, spanning from one tagged client request to another.

Embodiments of the present invention include a system, device, and method for integrating cache tagging tracking mechanisms and session management mechanisms. Such embodiments may use session management information to filter the relevant or desired client process information that spans a desired one or more sessions, for example, a current live client session.

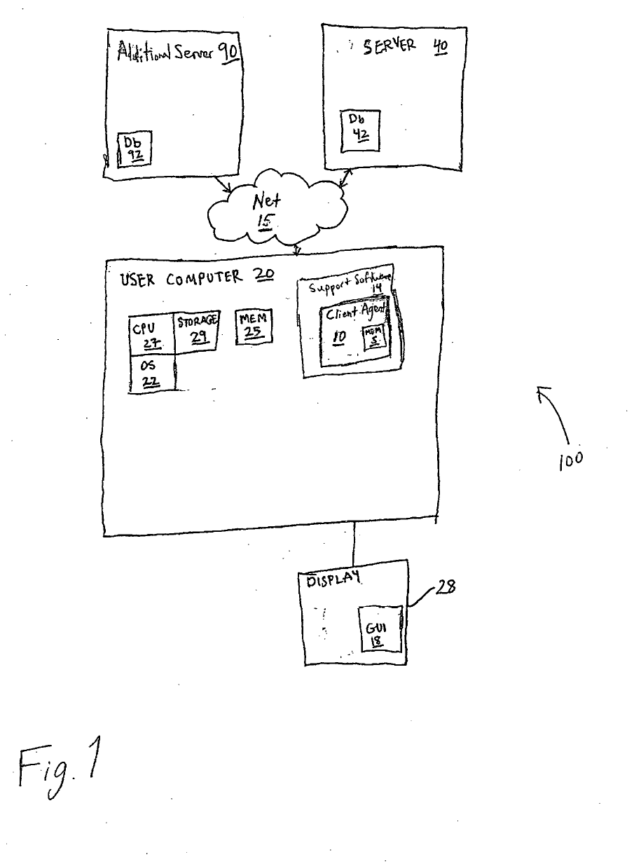

FIG. 1 schematically illustrates a persistent user tracking system, including one or more servers and one or more computers or terminals, for tracking client processes using cache tagging mechanisms, according to one embodiment of the present invention. Persistent user tracking system 100 may include one or more client computers 20, server 40, and one or more additional servers 90, having databases 42 and 92, respectively. Client computer 20 may include a memory 25, a processor 27, a monitor or output device 28, a storage device 29, an operating system 22, and client support software 14 and may operate a graphical user interface (GUI) 18, presented on display 28.

The server side or server end of a system may include components (e.g., remote server 40 and/or additional servers 90) that may track client end processes at the client side or end, for example, over client compute 20, by sending requests (e.g., for client side cached resource content. The client side or server side of the system may include components that may receive or transmit requests (e.g., using client agents 10 operating on a client computer or terminal 20 and domain resources operating for example over network 15 or at remote server 40), store (e.g., in a memory area at client computer 20 such as a client side agents' cache 5 or other memory area 25 or in database 42 of server 40), for providing client or server side components with responses to the requests, for example, including cached resource content, such as HTTP headers, and session management information. The client side and server side may communicate, for example, over a network 15 such as the Internet.

According to embodiments of the present invention, client side and/or server side components may use client cached resource content such as HTTP Cache headers, or tags or other markers associated therewith, to track or identify client processes executed, for example, over network 15, via client computer 20. Local client computer 20 and/or server 40 may include session management mechanisms for associating cached resource content with one or more client process sessions.

In one embodiment, client computer 20 may execute processes, for example, accessing a website supported by server 40. Server 40 may track client processes by identifying tags associated with cached resource content on the client side. Tags may be stored locally at the client site and/or remotely at one or more servers 40 and/or 90. In one embodiment, the identifying tags associated with cached resource content may be stored on the client side, for example, at client computer 20, additional server 90, which may not receive requests from client computer 20, may use the tagged cached resource content to track or identify client requests associated with server 40. In another embodiment, the identifying tags associated with cached resource content may be stored or accessed at the server side, for example, at one or more servers 40 and/or 90. The servers 40 and/or 90 storing the tags may selectively allocate the associated client cached resource content, or access thereto, to specific servers, for example, that have invested interest. Such embodiments may enable the specific selected servers that do not directly receive client requests to track or identify client requests associated with the server that received the request.

In such embodiments, any server with the appropriate support, access, and compatibility, such as server 40 and/or additional server 90, may access tagging client cached resource content to track client processes using cached tagging mechanisms, according to embodiments of the present invention

Embodiments of the present invention include a system and method for integrating cache tagging tracking mechanisms and session management mechanisms. Such embodiments may be used for associating cached resource content with one or more client sessions. Persistent tracking mechanisms may use session management information to filter the relevant or desired client process information that spans a desired one or more sessions, for example, a current live client session.

In some embodiments, servers and/or local clients may track relevant or desired client process information, for example, that spans one or more relevant or desired sessions. The relevant information may include a subset of cached resources stored in a data structure, with locations indicated, marked or bound, for example, by one or more client side or server side tagged cached resources. The relevant subset of cached resources may include, for example, a string of HTTP headers, or values associated therewith, spanning a data structure from one tagged client request to another.

In some embodiments, system 100 may include cache tagging mechanisms for executing at least two operations. The first operation may include persistently or periodically storing cached resource content, for example, HTTP cache headers, at the client side, for example, in memory 25 of client computer 20 or at the server side in a cache memory unit. Periodically storing may include for example storing according to any repeated time scheme, for example, at even intervals of time, according to a predetermined schedule, or in response to a signal, for example, a digital clock signal or a signal generated by client computer 20 or server 40. The second operation may include that, for example, when client computer 20 makes a repeat attempt to access a website supported server 40 and sends cached resource content including a URL for the website, server 40 may request the cached resource content, for example, including HTTP cache headers, from client computer 20. The cached resource content may be sent to server 40. Server 40 may evaluate the validity of the cached resource content, for example, using the HTTP cache headers as validators, and may thus, evaluate the accuracy of the first and second operations. In some embodiments, the cached resource content may include static data

In some embodiments, it may be desirable to append additional information onto the requested cached resource content. Embodiments of the present invention gain benefit from attaching session management information, for example, for a current client process session, to the requested cached resource content. Session management information may be generated by a session management mechanism of remote server 40 and/or 90 or local client computer 20. However, if additional information, for example, in the Query section [What is the Query section?], is appended or attached to the request for cached resource content, the request may not match or identify the appropriate cached resource content and the corresponding HTTP cache headers may not be associated and accessed with the request.

Embodiments of the present invention provide a system and method for requesting and associating corresponding cached resource content, such as HTTP cache headers, and additional information, such as session management information.

In one embodiment, a set of requests may be sent, for example, by server 40, server 90, and/or client computer 20, including for example two separate requests, such as a request for cache resource content, including for example, corresponding tag values, and a request for corresponding session management information. The set of requests may include other types of requests. The request for cache resource content may be linked or associated with the request for the corresponding session management information, for example, in order to link or associate a specifically tagged client to a specific one or more client process session such as a current live session. Both requests may be sent to server side or client side components with client tracking and/or fraud detection capabilities, such as, server 40.

Several embodiments may be provided for linking or associating at least two of the requests in the set of requests, for example, the request for cached resource content and the request for corresponding session management information. Once corresponding cached resource content and session management information are linked, client processes may be tracked over relevent or desired sessions or periods of time. In one embodiment a secure sockets layer (SSL) protocol session identification (ID) may be used to link or associate such requests. The SSL protocol and SSL session ID is known to those of ordinary skill in the art. In one embodiment, server 40 or client computer 20 may first request session management information, such as a local session token, which may be a non-cached resource. After the session management information request, server 40 or client computer 20 may separately request cached resource content may be redirected to the cached resource, for example, by a fraud-detection mechanism, for example, of server 40. If server 40 and/or client computer 20 operate according to SSL protocol, then the two requests may be sent with substantially the same identification tag, for example, a SSL session ID. The identification tag or SSL session ID may be selected at random and may provide a substantially unique code to substantially distinguish the two requests from others sent within a reasonable duration of time. In some embodiments, the order in which the two requests are sent may enable the requests to be marked with substantially the same identification tag. For example, if server 40 or client computer 20 first sends the request for the cached request, the fraud-detection mechanism redirection response may obstruct persistent caching of cached resource content such as HTTP Cache headers, thereby obstructing client processes tracking capabilities for at least a period of time.

An example follows of HTTP data used to link the two requests using SSL session IDs according to embodiments described hereinabove. The domain used by the server 40 fraud-detection mechanism may be similar to embodiments described in www.fraud-detection.com. The following example assumes that a client has previously accessed a website that the client may currently be accessing or re- accessing and therefore the cached resource content associated with the website domain or its server provider may be associated with a tag or other identification marker. However, it may be appreciated that the following example may also be used when the cached resource content has not been associated with a tag or marker.

In such an exemplary embodiment, a system operating according to the SSL protocol may include a first request sent, for example, from a website server or local client, to a non-cached resource. The request may include an embedded session token. The first request may include for example code as follows:

GET /non-cached.gif?session=<session-token>HTTP/1.1

Host: www.fraud-detection.com

The server or client may store the session token and may redirected the server or client with a first response. The first response may include for example code as follows:

HTTP/1.1 200 OK

Location: https://www.fraud-detection.com/cached.gif

The second request may be sent, for example, from the server or client, to a cached resource, directed according to the first response. The second request may include a request for cached resource content, for example, corresponding to the session indicated by the session token, and the corresponding validators, for example, including HTTP cached headers. The second request may include for example code as follows:

GET /cached.gif HTTP/1.1

Host: wwvw.fraud-detection.com

If-None-Match: <tagged-value>

Since, in such embodiments, the first and second requests and, for example, corresponding responses, may be generated during the same SSL session, the first and second requests may be provided with responses including substantially the same SSL session ID. The SSL session ID associate with each request may be identified, for example, by known fraud detection mechanisms. The fraud detection mechanism may compare SSL session IDs to link the first and second requests.

Another embodiment for linking the request for cached resource content and the request for corresponding session management information may include using proprietary session cookies. Such embodiments may be executed according to embodiments substantially similar to those using SSL session IDs, described hereinabove. Differences among such embodiments may include that responses to requests for session management information may include proprietary cookies so that when a request is redirected to the cached resource, a response to the request for cached resource content may include substantially the same cookie. The responses to the two requests may each include identification tags, for example, indicating the value of the response cookie, which may be used to link the two responses and/or requests. In some embodiments, websites may include default configurations and/or system standards, such as IE 6.0, may not accept cookies provided by a third party server, for example, unless they are accompanied by the platform for privacy preferences (P3P) policy. In such embodiments, the server 40 requests may additionally be provided an appropriate P3P policy compliant header with the proprietary cookies.

Another example follows of HTTP data used to link the two requests according to embodiments described hereinabove. The following example uses proprietary session cookies. As in the previous example, the same domain and repeated access thereto by a client is assumed, but not required.

In such an exemplary embodiment, a first request, which may be sent by a server or client, may include for example code as follows:

GET /non-cached.gif?session=<session-token>HTTP/1.1

Host: www.fraud-detection.com

A first response to the first request may include a proprietary cookie. The request may be redirected to a cached resource. The first response may include for example code as follows:

HTTP/1.1 200 OK

Location: http://www.fraud-detection.com/cached.gif

Set-Cookie: binding=<random-number>; domain=.fraud-detection.com

The second request may include cached resource content, for example, corresponding to the session indicated by the session token, and the corresponding validators, for example, including HTTP cached headers. The second request may include for example code as follows:

GET /cached.gif HTTP/1.1

Host: www.fraud-detection.com

A second response to the second request may also include a proprietary cookie. The server may compare the values associated with the cookies provided in the first and second responses to link the first and second requests. A comparison of the first and second responses may include for example code as follows:

If-None-Match:<tagged-value>

Cookie: binding=<random-number>

If the values associated with the cookies provided in the first and second responses substantially match, the two requests may be linked.

Another embodiment for linking the request for cached resource content and the request for corresponding session management information may include using a client-side code fragment as a cached resource. In one embodiment, server 40 and/or client computer 20 may first request cached resource content, which may include a client-side code fragment, for example, written in JavaScript. Substantially each distinct client-side code fragments may include a unique tag value. In such embodiments, substantially the same identification tag may be provided for the two requests. Since the cached JavaScript code for each cached resource may include the unique tag value, consecutive requests, generated for example, using client-side logic scheme, may include the tag value and session management information, such as a session token. In some embodiments, without obstructing persistent caching, the cached resource may store dynamic data, for example, the value of the cached resource content, in addition to static data, for example, an identification value associated with each client.

Another example follows of HTTP data used to link the two requests according to embodiments described hereinabove. The following example uses using a client-side code fragment as a cached resource. As in the previous example, the same domain and repeated access thereto by a client is assumed, but not required.

The following is sketch of one embodiment of the present invention:

<!-This is part of the HTML ...-->
<script>
function getSessionID( )
{

...
<!-logic that retrieves the FI's session ID - ->
...

}
</script>

| <!-- | Call the cached resource, which contains the implementation |
|---|---|
| | of getETag( ), that returns the tagged value. |

-->
<script src=http://www.fraud-detection.com/cached.js >
</script>

| | |
|---|---|
| <!-- | Now generate the second request which contains all the data --> |

<script>

| | | |
|---|---|---|
| document.write(“<img | src= | http://www.fraud-detection.com/non- |

cached.gif?etag=”+getETag( )+“&sessionID=”+getSessionID( )“>”);
</script>
<!-End of the HTML section ...-->

In one exemplary embodiment a sequence of requests and responses may requests be sent as follows:

In such an exemplary embodiment, a first request may include for example code as follows:

GET/cached.js HTTP/1.1
Host: www.fraud-detection.com
If-None-Match: <tagged-value>

The first response may include for example code as follows:

HTTP/1.1 200 OK
Content-Type: application/x-javascript
Cache-Control: private, must-revalidate, max-age=0
Etag: <tagged-value>
...
function getETag( )
{

return(<tagged-value>);
//Note: the tagged value appears in the JavaScript code itself,
//as the implementation of getETag, which is used when generating
//the second request.

| } | |
|---|---|
| GET | /non-cached.gif?etag=<tagged-value>&sessionID=<session-token> |

HTTP/1.1
Host: www.fraud-detection.com
...

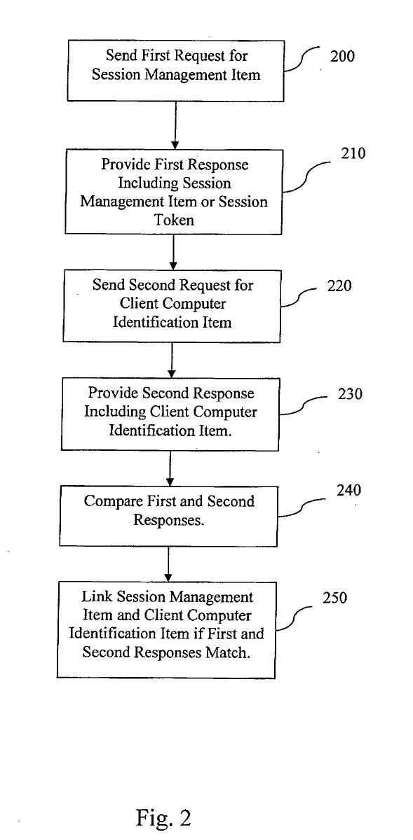

FIG. 2 is a flowchart of a method for persistent user tracking according to an embodiment of the present invention.

In operation 200, a client may access a specific server, for example, via a website. The remote server or local client may send a first request to a session management mechanism for a session management item. The request may include a request for session management information.

In operation 210, a remote server or local client may provide a first response. The first response may include associating the session management item, for example, with a first marker such as a session token or a tag or value associated therewith. In embodiments, the client computer identification item may be received by the server from the client computer by a code executed thereon. The marker may include, for example, a SSL session ID, a proprietary session cookie, program code or any other appropriate marker.

In operation 220, the remote server or local client may send a second request related to cached resource content such as a client computer identification item. The client computer identification item may be an attribute associated with cached resource content provided from the server to the client.

In operation 230, the remote server or local client may provide a second response. The second response may include associating the client computer identification item, for example, with a second marker, such as or a tag or value that matches or is substantially the same as the first marker or tag or value of operation 210. For example, the SSL session ID and proprietary cookie provided by the second response may be substantially similar to the SSL session ID and proprietary cookie provided by the first response, respectively.

In operation 240, the client may compare the first and second responses, for example, by comparing the first and second marker values.

In operation 250, if the first and second marker values are the same, the client may substantially match the first and second responses and link the session management item of the first request to the client computer identification item of the second request.

Other operations or series of operations may be used.

Various devices and architectures, and sets of devices, may form a system according to various embodiments of the present invention, and my effect a method according to embodiments of the present invention. Methods according to various embodiments of the present invention may, for example, be executed by one or more processors or computing systems (including, for example, memories, processors, software, databases, etc.), which, for example, may be distributed across various sites or computing platforms; alternatively some methods according to embodiments may be executed by single processors or computing systems. The following illustration outlines a solution architecture according to one embodiment of the present invention; other suitable architectures are possible in accordance with other embodiments of the invention.

Moreover the solution architecture example, pertains to the usage of this system and method by a financial institution (FI). It will be appreciated by persons skilled in the art that this system and method are not limited to use by financial institutions, but rather by any Service provider.

It will be appreciated by persons skilled in the art that embodiments of the invention are not limited by what has been particularly shown and described hereinabove. Rather the scope of at least one embodiment of the invention is defined by the claims below.

What is claimed is:

1. A method for persistent user tracking comprising associating a session management item with a client computer identification item, wherein said session management item and said client computer identification item are both associated with a single value of a marker.

2. The method of claim 1, wherein said marker is a secure sockets layer (SSL) protocol session identification.

3. The method of claim 1, wherein said marker is a session cookie.

4. The method of claim 1 comprising transmitting the session management item together with said value of said marker from a client computer to a server.

5. The method of claim 1, wherein said client computer identification item is an attribute associated with a resource provided from said server to said client computer.

6. The method of claim 5 comprising transmitting said resource having said attribute from a server to a client computer.

7. The method of claim 5 comprising transmitting the attribute together with said value of said marker from a client computer to a server.

8. The method of claim 5, wherein said attribute is a timestamp.

9. The method of claim 5, wherein said attribute is a tag.

10. The method of claim 1, wherein said session management item is a user name.

11. The method of claim 1, wherein said client computer identification item is received by a server from a client computer by a code executed thereon.

12. The method of claim 8, wherein said code is provided to said client computer.

13. The method of claim 8, wherein said client computer identification item is an attribute associated with a resource provided from a server to said client computer.

14. The method of claim 9, wherein said attribute is a timestamp.

15. The method of claim 9, wherein said attribute is a tag.

16. A method for persistent user tracking, comprising:
associating a first session management item, said first session management item pertaining to a session conducted by a user on a first server with a client computer identification item; and
associating a second session management item, said second session management item pertaining to a session conducted by said user on a second server with said client computer identification item.

17. The method of claim 13, wherein said client computer identification item is received from a client computer by a code executed thereon.

18. The method of claim 14, wherein said code is provided by said first and second server to said client computer.

19. The method of claim 14, wherein said client computer identification item is an attribute associated with a resource provided from said server to said client computer.

20. The method of claim 16, wherein said attribute is a timestamp.

21. The method of claim 16, wherein said attribute is a tag.

22. A device for persistent user tracking, comprising:
a processor adapted to associate a session management item with a client computer identification item, wherein said session management item and said client computer identification item are both associated with a single value of a marker; and
a memory to store a set of session management items with a respective set of associated client computer identification items.

23. The method of claim 22, wherein said marker is a secure sockets layer (SSL) protocol session identification.

24. The method of claim 22, wherein said marker is a session cookie.

25. The method of claim 22 comprising a transmitter for transmitting said session management item together with said value of said marker from a client computer to a server.

26. The method of claim 22, wherein said client computer identification item is an attribute associated with a resource provided from a server to a client computer.

27. The method of claim 26 comprising a transmitter for transmitting said resource having said attribute from a server to a client computer.

28. The method of claim 26 comprising a transmitter for transmitting said attribute together with said value of said marker from a client computer to a server.

29. The method of claim 26, wherein said attribute is a timestamp.

30. The method of claim 26, wherein said attribute is a tag.

31. The method of claim 22, wherein said session management item is a user name.

32. The method of claim 22, wherein said client computer identification item is received from a client computer by a code executed thereon.

33. The method of claim 32, wherein said code is provided by a server to said client computer.

34. The method of claim 32, wherein said client computer identification item is an attribute associated with a resource provided from a server to said client computer.

35. The method of claim 34, wherein said attribute is a timestamp.

36. The method of claim 34, wherein said attribute is a tag.
